(19) United States
(12) Patent Application Publication
(10) Pub. No.: US 2011/0193710 A1
(43) Pub. Date: Aug. 11, 2011

(54) REFRIGERATED CONTAINER MONITORING SYSTEM

(75) Inventors: Jason McIlvain, Manlius, NY (US); Fred Matrulli, Utica, NY (US); John W. Sammon, III, Clinton, NY (US)

(73) Assignee: PAR TECHNOLOGY CORPORATION, New Hartford, NY (US)

(21) Appl. No.: 12/701,151

(22) Filed: Feb. 5, 2010

(51) Int. Cl. G08B 17/00; F25D 3/00; B65D 88/00

(52) U.S. Cl. 340/585; 62/457.1; 220/1.5

(57) ABSTRACT

A monitoring system for a refrigerated container carrying temperature-sensitive cargo. The system includes sensors disposed throughout the container and/or an associated vehicle for measuring parameters of the container or vehicle, including temperature, motion, and fuel efficiency, among many others. The system optionally includes a global positioning system receiver to monitor geographic location. The system communicates with a command center to allow real-time tracking and monitoring of the container. To reduce false positive alerts, the system buffers alerts by at least 30 minutes and blocks signal transmission when the container is located within specified geofences such as loading and unloading sites.

### BACKGROUND OF THE INVENTION

1. Field of the Invention

The present invention relates to a monitoring system for temperature-sensitive cargo, and, more specifically, to a monitoring system for refrigerated trailers/containers.

2. Description of the Related Art

Every day, thousands of tons of temperature-sensitive cargo is shipped across the country and around the globe using refrigerated containers. This cargo includes cooled or frozen foods, adhesives, and pharmaceuticals, among many other things. The container used to ship these goods can be a refrigerated vehicle such as a car or a truck, a refrigerated trailer, or a refrigerated intermodal container also known as a “reefer” to those in the art. Intermodal containers, for example, can be transferred between trailers, boats, planes, and trains without requiring that the temperature-sensitive goods be unloaded.

Similar to any other mechanical system, refrigerated containers can break down or experience decreased efficiency, thereby threatening the quality of the perishable cargo. To maintain the quality of temperature-sensitive cargo during shipping, some shipping companies employ temperature monitoring systems that measure the internal temperature of the container. These monitoring systems also allow the shipper to satisfy strict shipping and temperature-control requirements set forth by the United States Food and Drug Administration.

Some shipping companies also employ geo-location systems that assist in reefer asset location and temperature management. These systems typically use a global positioning system (“GPS”) to determine the geographic location of the cargo and then transmit that location to the fleet management center.

Previous monitoring systems, however, frequently lack the ability to monitor an entire shipping fleet from a centralized command center in real-time. These monitoring systems are also unable to send an operable command from the command center back to the container system in response to obtained data. In addition, many of these temperature monitoring systems are unable to monitor or control several temperature zones in a single container and create a high number of false positives, thereby creating unnecessary, time-consuming, and expensive work for shipping managers.

### BRIEF SUMMARY OF THE INVENTION

It is therefore a principal object and advantage of the present invention to provide a refrigerated container monitoring system that monitors several parameters related to the container or vehicle involved in shipping temperature-sensitive cargo.

It is a further object and advantage of the present invention to provide a refrigerated container monitoring system that is configured to monitor the pressure of one or more tires of a refrigerated trailer or vehicle.

It is another object and advantage of the present invention to provide a refrigerated container monitoring system that monitors the temperatures of more than one temperature zone in the refrigerated container.

It is yet another object and advantage of the present invention to provide a refrigerated container monitoring system that prevents a significant percentage of false positive alert conditions.

It is a further object and advantage of the present invention to provide a refrigerated container monitoring system that is configured to transmit measurement data by cellular networks, satellite networks, RFID networks, and/or the Internet to a fleet management command center.

Other objects and advantages of the present invention will in part be obvious, and in part appear hereinafter.

In accordance with the foregoing objects and advantages, the present invention provides a monitoring system for a refrigerated container carrying temperature-sensitive cargo. The system includes at least one sensor, which measures, monitors, or describes a parameter of the container or cargo. The system also includes a motion sensor that detects movement of the container or an associated vehicle. A data processor communicates with the sensors and the motion sensor either directly or wirelessly. The processor compiles and processes that information into a signal that can be transmitted through networks such as satellite, RFID, or cellular networks. To accomplish this, the system includes a transceiver that receives the signal from the processor and transmits the signal to the network. The system also includes a control center that receives the signal from either the network or the Internet.

A second aspect of the present invention provides the previously described monitoring system with the addition of a global positioning system that determines the geographic location of the container. The system can include the location information in the signal that is transmitted to the control center. In a further aspect, the monitoring system does not transmit the signal to the control center if the container is located within specified geographic locations. This prevents the transmission of false positive alerts when the container, for example, is being loaded or unloaded at docking sites.

A third aspect of the present invention provides a monitoring system for a refrigerated container associated with a vehicle, in which the vehicle includes a driver display. The driver display receives information from the system about location and/or parameters of the container or vehicle. In one embodiment, the driver display alerts the driver if at least one of the measurements deviate outside a preprogrammed range.

A fourth aspect of the present invention provides a monitoring system for a refrigerated container which includes a receiver that receives a command from the command center. The command is any command capable of being received by the driver or capable of being carried out by the container, associated vehicle, or monitoring system.

A fifth aspect of the invention is a cargo sensor temperature probe alert. Individual cargo temperature sensor data is amalgamated and transmitted in real-time or near real-time to both web-based reporting systems and a driver/operator. The monitoring system alerts stakeholders in real-time or near real-time that the cargo sensor is reporting an out-of-range temperature and therefore that corrective action is necessary.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a flowchart showing a refrigerated container monitoring method according to one embodiment of the present invention;

FIG. 2 is a schematic representation of a refrigerated container monitoring method according to one embodiment of the present invention; and

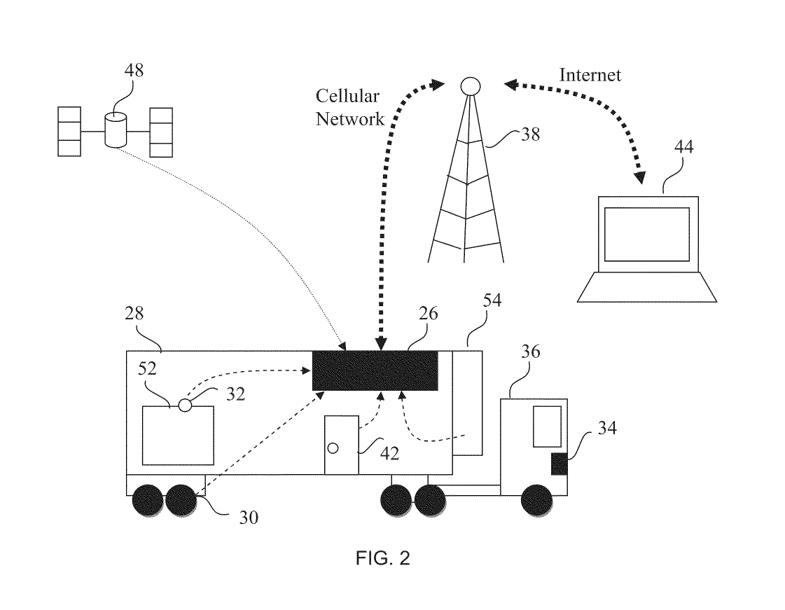

FIG. 3 is a representative screenshot of a fleet management program employing the refrigerated container monitoring system of the present invention.

### DETAILED DESCRIPTION OF THE INVENTION

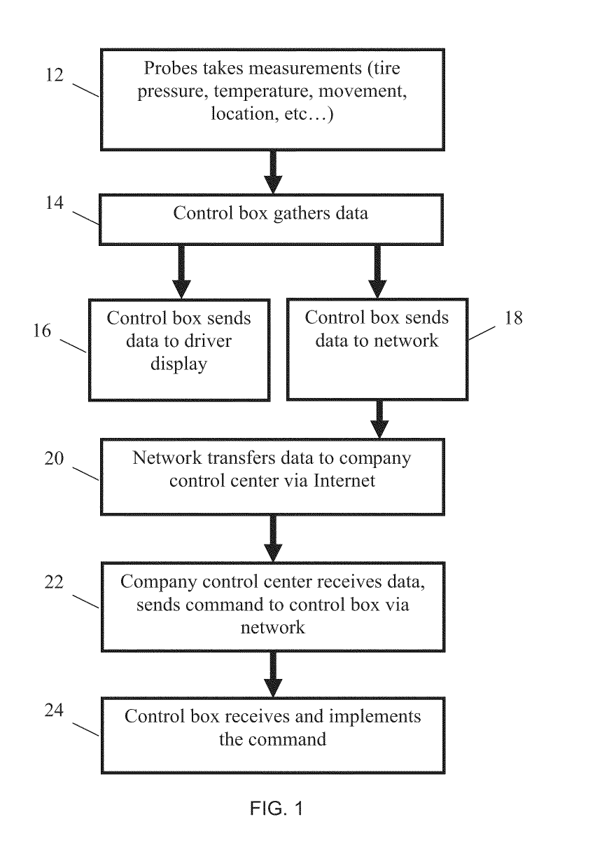

Referring now to the drawings, wherein like reference numerals refer to like parts throughout, there is seen in FIG. 1 a flowchart depicting a method of using the refrigerated container monitoring system 10 of the present invention. Although FIG. 1 depicts a refrigerated trailer, it will be understood by those skilled in the art that the system can be used to monitor any variety of refrigerated container, including, but not limited to, reefers and refrigerated vehicles. As an initial step 12, control box 26 takes a number of different physical measurements at random or pre-programmed intervals of time via probes distributed throughout the refrigerated container 28. In a preferred embodiment, control box 26 is mounted in or on refrigerated container 28 or the truck 36.

To manage the many functions of monitoring system 10, the system includes a data processor which receives information from the distributed probes, optionally stores that information, and processes the information for transmission to a driver display 34 or a fleet management center. The data processor can be any type of data processor know in the art. In a preferred embodiment, the data processor is compact and/or affordable hardware for inclusion inside control box 26. To store the information from the probes before or after it is processed for transmission, the management system includes data storage. The data storage can be separate from or an integral part of the data processor, and can be any type of data storage means known in the art, including a server, hard-drive, or flash-memory drive, among others.

Measurements obtained by control box 26 can include internal temperatures in one or more zones of the container, external temperature, tire pressure, diagnostics of the refrigeration system, motion sensing, location via GPS system 48 or a network, fuel levels, fuel consumption, alarm conditions, battery levels, truck diagnostics, door activity, and inventory, among many others.

In step 14, control box 26 gathers the measurements. To obtain measurements such as temperature or tire pressure, the probes are hard-wired to control box 26. For example, as shown in FIG. 1, control box 26 is connected to a tire pressure probe 30 via any method of creating a direct electrical connection known to those skilled in the art. Each of the trailer's tires can contain a tire pressure probe. Tire pressure probe 30 is programmed to obtain the pressure of the connected tire in response to a query from control box 26, or continuously monitors and reports tire pressure, or reports an alarm condition when the tire pressure exceeds or falls below pre-programmed levels.

Control box 26 in FIG. 1 is also connected to an internal temperature probe 32 via any method of creating a direct electrical connection known to those skilled in the art. In a preferred embodiment there are multiple internal temperature probes to monitor temperature conditions in multiple zones throughout the interior of refrigerated container 28. Internal temperature probes 32 are programmed to obtain the temperature of the internal zone in response to a query from control box 26, or continuously monitor and report temperature, or report any alarm condition when a monitored temperature exceeds or falls below pre-programmed levels. To closely monitor the temperature of cargo loaded inside refrigerated container 28, the temperature probes can be configured to insert directly into the cargo 52, or in very close proximity to the cargo.

In a preferred embodiment, control box 26 is also connected to a door monitor via any method of creating a direct electrical connection known to those skilled in the art. The door monitor collects information about the operation of the door 42, including opening or closing events, as well as the total time that door 42 is open or closed.

Control box 26 in FIG. 1 is also connected to the refrigeration unit 54 via any method of creating a direct electrical connection known to those skilled in the art. Any number of sensors or probes can be built into, integrated into, or installed into refrigeration unit 54 in order to detect and monitor various operating variables of the unit. The refrigeration unit, and hence the probes or sensor(s), can be located anywhere on the container or associated vehicle as is known in the art.

There are many other types of probes or data collection mechanisms employed to monitor pertinent conditions. For example, a GPS receiver, satellite network receiver, or cellular network receiver is mounted directly within control box 26 or is mounted elsewhere on container 28 or the truck, as are external temperature probes and motion sensors. Other monitoring systems can be wired throughout the container or associated vehicle and connected via direct electrical connection to control box 26, including conditions of the container's refrigeration system, fuel levels and consumption, mileage, battery levels, door activity, or any other truck or container diagnostics.

In an alternative embodiment, one or more of the probes transmit data to the control box wirelessly, or are hard-wired to a wireless transmitter rather than being in direct electrical communication with control box 26 via wiring or other transmission means. Additionally, any of the probes or sensors can optionally be stored in a pouch or other container when not in use in order to protect and/or inactivate the probe or sensor.

Control box 26 can also be configured to store measurements obtained from the monitoring devices or to send measurements as soon as they are obtained. Stored measurements can be used to calculate trends over time or rates of change. These calculated rates can then be used to predict future conditions, among other things. In a preferred embodiment, the measurements or the calculated information is stored in the storage means of control box 26.

In a preferred embodiment, the control box contains a motion sensor (not shown) such as an accelerometer, MEMS inertial sensor, or other method of detecting motion known to those skilled in the art. The motion sensor detects movement of the container or associated vehicle and reports that movement to control box 26 when motion starts or stops, or at pre-programmed intervals of time. A history of motion sensing allows fleet management to monitor several important variables involving the container.

Control box 26 can also contain a backup battery (not shown) to power the box when the box or container is not connected to a power source, or if the primary power source fails. In a preferred embodiment, the backup battery is rechargeable.

In step 16, control box 26 sends all or some of the obtained measurements and/or calculated data to a driver display 34. In a preferred embodiment, driver display 34 is mounted inside truck 36 in the driver's line of sight. Driver display 34 is hard-wired to control box 26 for direct transmission of obtained data. Obtained data can also be wirelessly transmitted to driver display 34, thereby avoiding a direct hard-wired connection. Driver display 34 can display some or all of the data, or can function only to notify the driver in the event of an alert condition when any obtained measurement falls outside a pre-programmed range.

In step 18, control box 26 sends all or some of the obtained measurements and/or calculated data to a transmitter/transceiver (not shown), which in turn transmits the data to a network. The network can be any type of network capable of receiving and transmitting signals, including, but not limited to, a satellite network or a cellular network. FIG. 1, for example, depicts a cellular network according to a preferred embodiment. In the event that the network receiver is not in range, monitoring system 10 stores the data until a signal can be transmitted to the network. For the cellular network, the signal transmission can be achieved by any method of transmitting data via a cellular network known in the art, including SMS, fax, or email.

In step 20, the network transfers the transmitted data to a company control center 44 via the Internet. One advantage of making the data available over the Internet is that it may be securely accessed anywhere there is Internet access. Accordingly, entities such as sales representatives, repair technicians, or shipping customers can access the information wherever and whenever it is needed.

In another embodiment, the network transfers the transmitted data to an IP address, server, or other Internet address or location as designated by the monitoring system. Accordingly, the system can alert the proper organization or individual of a certain parameter or condition of the refrigerated container in real-time. For example, monitoring system 10 can be programmed to deliver any alert involving the condition of the refrigeration unit directly to a maintenance division so that the division can act on the information.

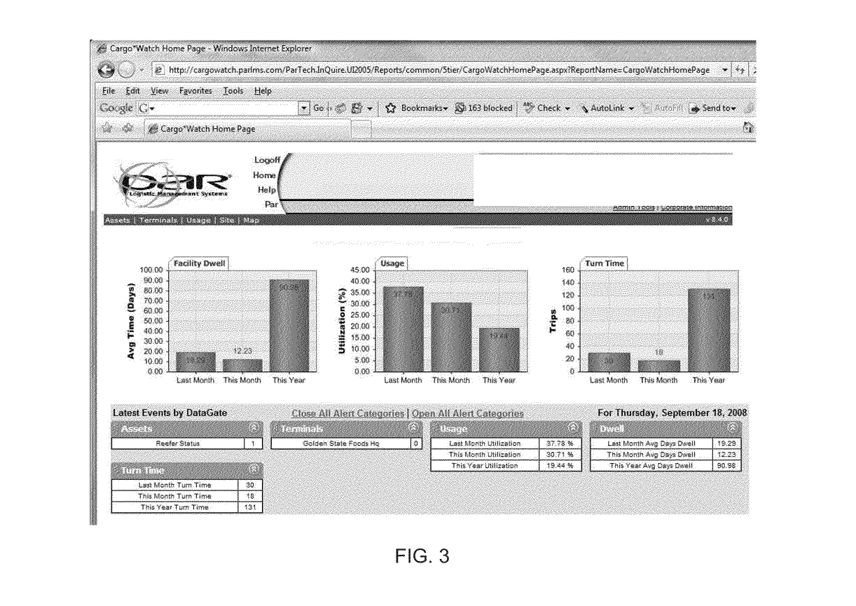

In step 22, company control center 44 receives and analyzes the data, and then optionally sends a command to control box 26 via network 40. In one embodiment, the data is received by or fed into a web-based application that provides configurable analysis of the data. A representative report from a web-based application is shown in FIG. 3. In another embodiment, the data is received by or fed into a computer-based software application that provides configurable analysis of the data. In both embodiments, the monitoring system is adapted to provide alerts, product alarms, standard temperature and historical reporting. The monitoring system can otherwise be adapted to provide any alert, measurement, or report required by a particular customer. Table 1 shows a representative report history of a refrigerated container that has experienced a refrigeration malfunction.

TABLE 1
Sample Report History

| Type of Report | Time | Reported Conditions |
|---|---|---|
| Reefer Powered On | 7:15 AM | Trailer ID Number, Location, Reefer Status, Temperatures, |
| | | Battery Status, Fuel Levels, & Engine Run Hours |
| Begin Move | 8:00 AM | Trailer ID Number, Location, Reefer Status, Temperatures, |
| | | Battery Status, Fuel Levels, & Engine Run Hours |
| In Transit Status | 8:30 AM | Trailer ID Number, Location, Reefer Status, Temperatures, |
| Report | | Battery Status, Fuel Levels, & Engine Run Hours |
| In Transit Status | 9:00 AM | Trailer ID Number, Location, Reefer Status, Temperatures, |
| Report | | Battery Status, Fuel Levels, & Engine Run Hours |
| In Transit Status | 9:30 AM | Trailer ID Number, Location, Reefer Status, Temperatures, |
| Report | | Battery Status, Fuel Levels, & Engine Run Hours |
| In Transit Status | 10:00 AM | Trailer ID Number, Location, Reefer Status, Temperatures, |
| Report | | Battery Status, Fuel Levels, & Engine Run Hours |
| 10:09 AM | Reefer | Trailer ID Number, Location, Reefer Status, Temperatures, |
| | Failure | Battery Status, Fuel Levels, & Engine Run Hours |

In a preferred embodiment, monitoring system 10 is configured for a fleet management administrator to enter an operable command into the web interface or computer-based software application which is then transmitted to control box 26 by the Internet and/or network 40. In step 24, control box 26 receives and implements the command sent by the web interface or computer-based software application. For example, the command can be a directive to increase report frequency, to activate or inactivate specific measurement capabilities, to activate or inactivate refrigeration, to increase or decrease refrigeration, or to notify the driver of an alert condition, among many others.

Refrigerated truck monitoring system 10 can optionally be configured to reduce false positives, which includes one or more of the following modifications. In one embodiment, monitoring system 10 is active when container 28 is being loaded or unloaded at a distribution or maintenance center, but the system is programmed not to activate alert conditions, or is programmed to activate a wider range of acceptable measurements when container 28 is not in motion for a certain amount of time. Similarly, system 10 is programmed to filter out all out-of-range measurements when container 28 is located within designated geographic perimeters, also known as a “geofence.” Other conditions known to result in false positives or alarm conditions are actions at delivery points including door openings and removal of probes. To eliminate or reduce these false positives, control box 26 is pre-programmed to buffer all or most alerts by a certain amount of time. For example, an alarm can be buffered by 30 minutes before it is reported; if the condition has resolved, the alarm will ultimately not be reported. Another condition that can result in alarm buffering is the natural power cycle of the refrigeration unit.

More false positive conditions or alerts can arise in a container with more than one temperature zone. The temperature of these zones can be changed or eliminated when goods are delivered from or loaded onto the container. To eliminate or reduce false positive alerts, each zone in a multi-zone configured container has its own probe with its own pre-programmed range of proper temperatures. The probes can be activated, deactivated, or ignored if the associated temperature zone is no longer needed, or can be adjusted to monitor a different temperature zone.

Although the present invention has been described in connection with a preferred embodiment, it should be understood that modifications, alterations, and additions can be made to the invention without departing from the scope of the invention as defined by the claims.

What is claimed is:

1. A monitoring system for a refrigerated container comprising temperature-sensitive cargo, the monitoring system comprising:
a plurality of sensors, each of said sensors adapted to describe at least one parameter of said container or said cargo;
a motion sensor adapted to detect movement of said container, and further adapted to generate a first signal in response to said movement;
a data processor in communication with said plurality of sensors and said motion sensor, said data processor adapted to receive said parameter descriptions and said first signal, and further adapted to process said parameter descriptions and said first signal into a second signal capable of transmission;
a transceiver in communication with said data processor and adapted to transmit said second signal to a signal network; and
a control center, said control center adapted to receive said second signal.

2. The monitoring system of claim 1, further comprising:
a vehicle; and
a driver display device located in said vehicle and in communication with said data processor, the driver display device adapted to receive sand transmittable signal and further adapted to display at least a portion of said transmittable signal.

3. The monitoring system of claim 2, wherein said driver display device is in wireless communication with said data processor.

4. The monitoring system of claim 3, wherein said driver display is further adapted to alert a driver if at least one of said parameters deviates outside a predetermined range.

5. The monitoring system of claim 3, wherein said data processor is further adapted to transmit said second signal to said driver display if at least one of said parameters deviates outside a predetermined range.

6. The monitoring system of claim 1, wherein said data processor is in direct communication with at least one of said plurality of sensors.

7. The monitoring system of claim 1, wherein said data processor is in wireless communication with at least one of said plurality of sensors.

8. The monitoring system of claim 1, further comprising a battery in communication with said data processor.

9. The monitoring system of claim 1, further comprising:
a vehicle; and
wherein at least one of said plurality of sensors is a tire pressure sensor, said tire pressure sensor in communication with a tire of said vehicle and adapted describe the air pressure inside said tire.

10. The monitoring system of claim 1, wherein at least one of said plurality of sensors is a temperature sensor.

11. The monitoring system of claim 8, wherein said temperature sensor is in communication with said cargo and adapted to describe the temperature of said cargo.

12. The monitoring system of claim 8, wherein at least two of said plurality of sensors is a temperature sensor, each of said temperature sensors in communication with at least one of a plurality of different temperature zones located within said refrigerated container.

13. The monitoring system of claim 1, wherein at least one of said plurality of sensors is in communication with a door located on said refrigerated container, said sensor adapted to describe whether said door is opened or closed.

14. The monitoring system of claim 1, further comprising:
data storage means in communication with said data processor.

15. The monitoring system of claim 12, wherein said data storage means is adapted to store said parameter descriptions and said first signal.

16. The monitoring system of claim 12, wherein said data storage means is adapted to store said second signal.

17. The monitoring system of claim 1, wherein said data processor is adapted to calculate changes in said parameter descriptions over time.

18. The monitoring system of claim 1, wherein said second signal is transmitted from said network to the Internet, and said control center receives said second signal from the Internet.

19. The monitoring system of claim 1, wherein said control center is further adapted to transmit a command to said network, and further comprising:
a receiver in communication with said data processor and adapted to receive said command from said network.

20. The monitoring system of claim 1, wherein said second signal is transmitted to said network at predetermined intervals of time.

21. The monitoring system of claim 1, wherein said second signal is transmitted to said network when at least one of said parameters deviates outside a predetermined range.

22. The monitoring system of claim 18, wherein the data transmission is buffered by at least 30 minutes.

23. The monitoring system of claim 1, wherein said network is a satellite network.

24. The monitoring system of claim 1, wherein said network is a cellular network.

25. A monitoring system for a refrigerated container comprising temperature-sensitive cargo, the monitoring system comprising:
a plurality of sensors, each of said sensors adapted to describe at least one parameter of said container or said cargo;
a motion sensor adapted to detect movement of said container, and further adapted to generate a first signal in response to said movement;
a global positioning system receiver adapted to calculate the geographic location of said receiver;
a data processor in communication with said plurality of sensors and said motion sensor, said data processor adapted to receive said parameter descriptions, said first signal, and said geographic location, and further adapted to process said parameter descriptions, said first signal, and said geographic location into a second signal capable of transmission;
a transceiver in communication with said data processor and adapted to transmit said second signal to a network; and
a control center, said control center adapted to receive said second signal.

26. The monitoring system of claim 25, wherein said second signal is transmitted to said network when at least one of said parameters deviates outside a predetermined range.

27. The monitoring system of claim 26, wherein said the transmission of said second signal is buffered by at least 30 minutes.

28. The monitoring system of claim 27, wherein the transmission is not sent if the at least one of said parameter is within said predetermined range when said at least 30 minutes ends.

29. The monitoring system of claim 26, wherein the transmission is not sent if said global positioning system receiver is located within a predetermined geographic location.

30. The monitoring system of claim 25, wherein said second signal is transmitted to said network at predetermined intervals of time.
